(19) United States
(12) Patent Application Publication
(10) Pub. No.: US 2024/0240832 A1
(43) Pub. Date: Jul. 18, 2024

(54) SOLAR WATER HEATING SYSTEM UTILIZING A FLAT-SHAPED HEAT PIPE

(71) Applicant: Kambix Innovations, LLC, Albuquerque, NM (US)

(72) Inventors: Kambiz Vafai, Mission Viejo, CA (US); Methida Siritan, Chiang Rai (TH); Phrut Sakulchangsatjatai, Chiang Mai (TH)

(21) Appl. No.: 18/411,007

(22) Filed: Jan. 11, 2024

Related U.S. Application Data
(60) Provisional application No. 63/439,112, filed on Jan. 14, 2023.

(51) Int. Cl. F24S 10/95; F24S 10/20; F24S 10/30; F28D 15/02; F28D 15/04

(52) U.S. Cl. CPC F24S 10/95; F24S 10/20; F24S 10/30; F28D 15/0233; F28D 15/04

(57) ABSTRACT

A solar water heating system can be implemented utilizing an innovative flat-shaped heat pipe as a primary heat transfer device. The system can include two small insulated rectangular ducts at the top and a large insulated rectangular duct at the bottom of the flat-shaped heat pipe. An absorber, positioned to receive, collect, and transfer solar heat, can be integrated into the system, complemented by a glass cover to minimize heat loss. The flat-shaped heat pipe, which can be constructed from a copper plate with porous wicks on its inner surfaces, can be filled with a working fluid. Solar irradiation incident through the glass cover on the absorber triggers the evaporation of the working fluid, absorbing latent heat. Subsequently, the vapor moves and transfers evenly to both sides of the flat-shaped heat pipe, facilitating the transfer of heat to water flowing through the rectangular ducts situated outside the flat-shaped heat pipe. This configuration optimizes energy efficiency, offering a reliable and cost-effective solution for solar water heating applications.

### CROSS REFERENCE TO PROVISIONAL APPLICATION

This patent application claims priority under 35 U.S.C. § 119 to U.S. Provisional Patent Application Ser. No. 63/439,112 entitled “An Innovative Design for a Solar Water Heating System Utilizing a Flat-Shaped Heat Pipe,” which was filed on Jan. 14, 2023 and is incorporated herein by reference in its entirety.

### TECHNICAL FIELD

Embodiments relate to devices, systems and methods for increasing the thermal performance of a solar water heating system. Embodiments further relate to flat-shaped heat pipes that are used as heat transfer devices.

### BACKGROUND

Renewable energy derived from natural resources has become a popular substitute for fossil fuels, due to replenishment itself and an inexhaustible source of energy. In addition, the reduction in usage of fossil fuels by using renewable energy decreases air pollution and global warming. Solar energy has emerged as a frontier for renewable energy sources because it can be harnessed for many technologies such as solar water heating, seawater desalination technology combined with solar water heating, solar thermochemical cycles, solar transportation, solar cells, solar lighting, and others.

The basic function of a solar water heating system is the conversion of solar radiation into heat. The application of solar collectors depends on the water temperature range that is required and reachable. A compound parabolic collector (CPC) can provide a water temperature range of 80 to 250° C. due to its ability to concentrate the solar radiation along with ray tracing. However, typical solar collectors for domestic hot water can be categorized as flat plate collectors (FP) and evacuated tube collectors (ET). The evacuated tube collector has a higher thermal efficiency for larger operations and lower efficiency losses as compared to a flat plate collector. The geometry of the evacuated tube collector can include two concentric borosilicate glass tubes, which can be evacuated at the annular space with a selective coating on the outer surface of the inner tube.

Heat losses from the collector decrease, and the majority of the absorber area can receive quasi-normal incidence radiation. Moreover, it has been classified by its working fluid type as (a) Water-in-glass, (b) U-type or Single-phase opened thermosyphon, and Two-phase closed thermosyphon. The water-in-glass evacuated tube solar collector has disadvantages such as not being suitable for places with extremely cold winters because of water freezing problems. In addition, it cannot adapt to buildings designed for a high level of sustainability, and reverse flow occurs at night. Furthermore, its thermal efficiency and storage energy were less than the U-tube and two-phase closed thermosyphon evacuated tube solar collector.

The U-tube evacuated tube solar collector includes an evacuated tube, a copper U-tube, and fins that touched the inner evacuated tube and the copper U-tube. Its operation is based on the solar radiation being incident on the inner evacuated tube and subsequently, the U-tube absorbs and exchanges heat to water flow inside the U-tube. The U-tube evacuated tube solar collector has been experimentally examined to develop a numerical model for predicting the hot outlet water temperature. It was found that results from the model had good agreement with the experimental results. The results also indicated that higher hot outlet water temperatures occurred with higher solar intensities and lower mass flow rates. The two-phase closed thermosyphon evacuated tube solar collector composes of an evacuated tube, a heat transfer device, and fins that touched the inner evacuated tube and the heat transfer device. Two main types of heat transfer devices can be classified by wick inside the tube: wick and wickless types.

In some cases, an evacuated tube solar water heating system can be designed and constructed with a heat pipe. This system can include six evacuated tubes, six copper heat pipes, and a 200 L water storage tank with a mass flow rate in the range of 0.03-0.032 kg/s. The structure of the heat pipe can include a 12.7 mm outer diameter, 1,550 mm evaporator section length, 300 mm condenser section length, two layers of 100-mesh stainless steel screen forming the wick inside, and acetone as the working fluid. The result have indicated that the highest thermal efficiency of the system and the outlet water temperature was 55.6% and 48° C., respectively. In addition, they also presented the optimum ratio of the evaporator to the condenser section length to absorb more heat and increase the amount of useful heat.

Others have experimentally investigated an evacuated tube solar water heating system with a heat pipe which was tested based on a real consumption pattern in the testing period. This system included fifteen evacuated tubes, fifteen copper heat pipes, and a 130 L water storage tank (a 2-kW power auxiliary electric heater was placed inside) with various mass flow rates as 0.6, 1.1, 1.6, and 2.1 L/m. The structure of the heat pipe was composed of a 16.2 mm outer diameter, 100 condenser section length, screen mesh as a wick inside, and water as the working fluid. Their results indicated that the maximum outlet water temperature was 64° C. in the evening, and the decreasing mass flow rate exhibited higher thermal performance of the system. With regards to applying the wickless type heat transfer device in the evacuated tube collector, experimentally studies have been performed on an evacuated tube solar water heating system with a thermosyphon. This system included eight evacuated tubes, eight thermosyphons, and a 100 L water storage tank with a mass flow rate of 0.03 kg/s. The structure of the thermosyphon was made of a copper tube with 15.60 mm and 22.25 mm lengths for the evaporator and condenser sections, respectively. In addition, it was composed of 1,700 mm, 150 mm, and 100 mm evaporator, adiabatic, and condenser sections length, respectively, and filled with R141 with 70% of the evaporator volume. Their experimental results showed that the maximum hot water temperature was 65.25° ° C. in the evening.

Other designs have included an optimal closed-loop pulsating heat pipe in an evacuated tube solar water heating system. The system consisted of ten evacuated tubes, a set of closed-loop pulsating heat pipes, and a 100 L water storage tank with a mass flow rate of 0.15 kg/s. They displayed the optimal size of the closed-loop pulsating heat pipe to be a 1.5 mm inner diameter of the tube, and evaporator, adiabatic, and condenser sections lengths of 1,250 mm, 50 mm, and 300 mm, respectively, 4 sets of 20 turns per set, filled with R123 occupying 50% of the volume of the tube. The maximum water temperature was achieved at 62.3° C. This study particular mentioned that increasing the evaporator section has an effect on increasing evaporator temperature since the surface area of the evaporator section is increased while the surface area of the condenser section is limited by its water storage tank. Due to this, thermal energy is accumulated in the evaporator section more than transferred to the water, resulting in an increase in thermal resistance and leading to dry-out of the tube for the CLPHP.

Based on a literature review, it can be concluded that the discussed heat pipes which are applied in the evacuated tube solar water heating system have a number of limitations, for instance, they can only transfer heat in one direction, and the condenser area of the heat pipe is limited because of the water storage tank (or manifold) design. Several studies have attempted to increase the thermal efficiency of the system by adding nanoparticles to a traditional working fluid to substantially increase heat transfer properties, adding a fine wire mesh to achieve a uniform flow, and developing a novel porous absorber with a variable pore structure. However, these solutions do not eliminate the limitations of the traditional heat pipes which are applied in solar water heating systems.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an improved solar water heaty system.

It is another aspect of the embodiments to provide for improved devices, systems and methods for increasing the thermal performance of a solar water heating system.

It is also an aspect of the embodiments to provide for a flat-shaped heat pipe that can be used as a heat transfer device.

The aforementioned aspects and other objectives and advantages can now be achieved as described herein.

In an embodiment, a solar water heating system can include a flat-shaped heat pipe comprising a heat transfer device.

In an embodiment, a plurality of insulated rectangular ducts can be located at a top of the flat-shaped heat pipe.

In an embodiment, an insulated rectangular duct can be located at a bottom of the flat-shaped heat pipe.

In an embodiment, an absorber can be implemented, which receives, collets and transfers heat to the flat-shaped heat pipe.

In an embodiment, a glass cover can be utilized, which reduces heat loss from the absorber.

In an embodiment, the flat-shaped heat pipe can include a copper plate, which can include porous wicks located on an inner surface of a wall of the flat-shaped heat pipe.

In an embodiment, the flat-shaped heat pipe can be filled with a working fluid.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the embodiments.

FIG. 1 illustrates a schematic diagram depicting a solar water heating system with a Flat-Shaped Heat Pipe, in accordance with an embodiment;

FIG. 2 illustrates a perspective view of a parametric representation of a Flat-Shaped Heat Pipe, in accordance with an embodiment;

FIG. 3A and FIG. 3B illustrate graphs depicting a comparison of the vapor and liquid pressure distributions along the flat-shaped heat pipe;

FIG. 4A and FIG. 4B illustrates graphs depicting a comparison of the vapor temperature profiles along the flat-shaped heat pipe, in accordance with an embodiment;

FIG. 5 illustrates a graph depicting a comparison between analytical and experimental results;

FIG. 6 illustrates a graph depicting the heat loss from the collector to the environment for different heat transfer devices for solar water heating systems;

FIG. 7 illustrates a graph depicting the effect of the mass flow rate on water temperature difference between inlet and outlet of the tube, in accordance with an embodiment;

FIG. 8 illustrates a graph depicting the effect of the mass flow rate on water temperature difference between the inlet and outlet of the tube for the difference incident solar irradiation;

FIG. 9 illustrates a graph depicting thermal resistance for different heat transfer devices for a solar water heating system;

FIG. 10 illustrates a graph depicting the effect of the condenser section length of the flat-shaped heat pipe on the effective thermal conductivity, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part. In addition, identical reference numerals utilized herein with respect to the drawings can refer to identical or similar parts or components.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Flat-shaped heat pipes (FS-HP) ha can be readily set up as a heat transfer device in a solar water heating system due to their shape (an evaporator section on the top center, two identical condenser sections on the top and a larger continuous condenser section on the bottom, and vapor regions with wicks and working fluid inside), along with the second feeding mechanism by the vertical wicks in the vapor regions. This system is ideal to fully incorporate the asymmetrical heat load. As such, they can fully overcome the limitations of cylindrically shaped heat transfer devices. The embodiments describe innovative design of a solar water heating system using a flat-shaped heat pipe as a heat transfer device, which can pave the way to substantially increase the thermal performance of the system.

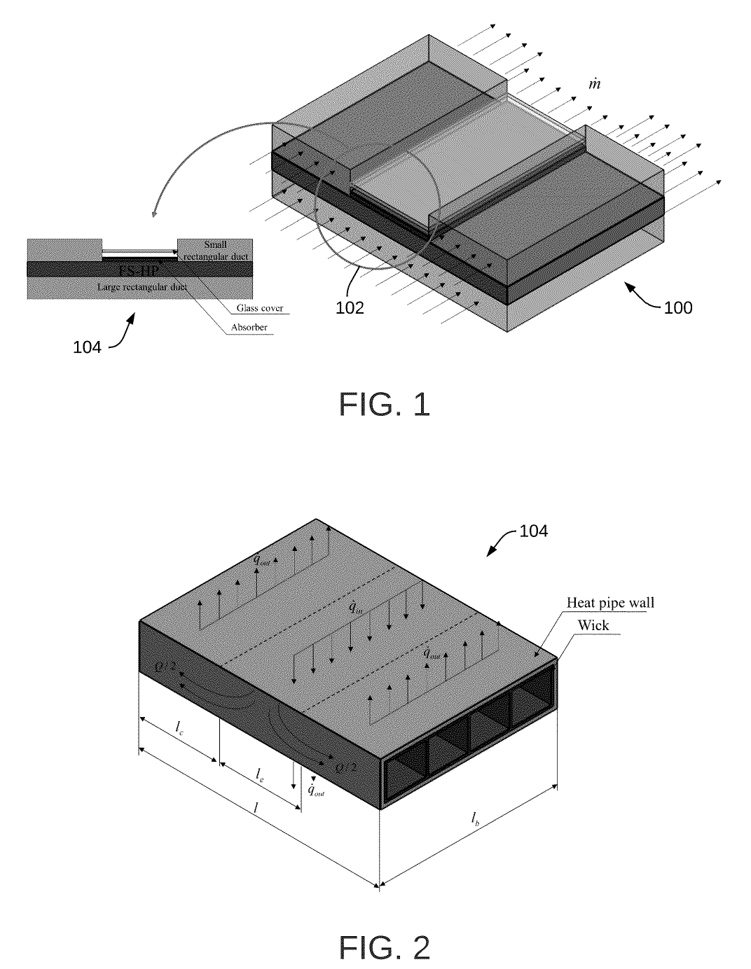

FIG. 1 illustrates a schematic diagram depicting a solar water heating system 100 with a flat-shaped heat pipe 104, in accordance with an embodiment. The flat-shaped heat pipe 104 is indicated by the circular inset 102 shown in FIG. 1. The solar water heating system 100 comprises the flat-shaped heat pipe 104 as a heat transfer device, including two small insulated rectangular ducts at the top of the flat-shaped heat pipe 104, along with a large insulated rectangular duct at the bottom of the flat-shaped heat pipe, 104 an absorber to receive, collect, and transfer heat from the sun to the flat-shaped heat pipe 104, and a glass cover to reduce heat loss from the absorber. Generally, the flat-shaped heat pipe 104 can be configured form a copper plate, which can include porous wicks on the inner surfaces of the flat-shaped heat pipe wall. In addition, the flat-shaped heat pipe 104 can be filled with a working fluid. When solar irradiation is incident through the glass cover on the absorber, the working fluid inside the flat-shaped heat pipe 104 evaporates to vapor as it absorbs the latent heat. After that, it moves and transfers equally to both sides of the heat pipe heat to water which flows through the flat-shaped heat pipe 104 in rectangular ducts (situated outside the flat-shaped heat pipe).

### Flat-Shaped Heat Pipe Model and Analysis

Table 1 shows the nominal values for the innovative design for a solar water heating system with a flat-shaped heat pipe 104 and various heat transfer devices in the evacuated tube solar water heating system 100, for instance, U-tube, thermosyphon, and closed-loop pulsating heat pipe systems.

FIG. 2 illustrates a perspective view of a parametric representation of the flat-shaped heat pipe 104, in accordance with an embodiment. When the solar radiation incidents on the absorber and transfers heat through the flat-shaped heat pipe 104, the heat is transferred equally to both sides of the condenser section of the flat-shaped heat pipe 104 as displayed in FIG. 2.

Detailed comprehensive analytical solutions for the vapor pressure distribution, liquid pressure distribution, and temperature distribution for the flat-shaped heat pipe 104 are discussed herein in order to ensure that the model can accurately predict the thermal performance of the innovative design for a solar water heating system with the flat-shaped heat pipe 104. There are four common assumptions, which can be made in analyzing the flat-shaped heat pipe: (1) Vapor and liquid flow are steady, laminar, and subsonic. (2) Vapor and liquid transport properties are taken as constants. (3) Evaporator and condenser sections have uniform vapor injection and suction rates. (4) The vapor velocity in the z direction is negligible because there is no injection or suction on the vertical wicks. Based on the analysis given in these works, we can obtain the vapor and liquid pressure and temperature distributions of the flat-shaped heat pipe 104, as shown in Eqs. (1)-(4) to validate our analytical model.

TABLE 1
Nominal values for various heat transfer devices in solar water heating systems

| Type of heat | Component | | Nominal | | |
|---|---|---|---|---|---|
| transfer device | of system | Parameter | value | Unit | Researcher |
| FS-HP | Collector | Width (l_{b}) | 2,000 | mm | The present |
| | | Length (lₑ) | 1,000 | mm | work |
| | FS-HP | Width (l_{b}) | 2,000 | mm | |
| | | Length (l) | 3,000 | mm | |
| | | Wick | sintered copper | | |
| | | | powder | | |
| | | Working fluid | heavy water | | |
| | | | (D₂O) | | |
| | | Wick thickness | 1.651 | mm | |
| U-tube | Collector | Diameter | 47 | mm | Ma et al. |
| | | Length | 1,200 | mm | |
| | | Number of tubes | 1 | tube | |
| | U-tube | Diameter | 8 | mm | |
| | | Length | 1,200 | mm | |
| Thermosyphon | Collector | Diameter | 47 | mm | Wannagosit |
| | | Length | 1,800 | mm | et al. |
| | | Number of tubes | 8 | tube | |
| | Thermosyphon | Evaporator diameter | 15.88 | mm | |
| | | Condenser diameter | 22.22 | mm | |
| | | Evaporator length | 1,700 | mm | |
| | | Condenser length | 100 | mm | |
| | | Adiabatic length | 150 | mm | |
| | | Working fluid | R141 | | |
| | | Filling ratio | 70% of the | | |
| | | | evaporator | | |
| | | | volume | | |
| CLPHP | Collector | Diameter | 47 | mm | Siritan et al. |
| | | Length | 1,800 | mm | |
| | | Number of tubes | 10 | tube | |
| | CLPHP | Diameter | 1.5 | mm | |
| | | Evaporator length | 1,250 | mm | |
| | | Condenser length | 300 | mm | |
| | | Adiabatic length | 50 | mm | |
| | | Number of turns | 20 | turn | |
| | | Number of sets | 4 | set | |

| | |
|---|---|
| Working fluid | R123 |
| Filling ratio | 50% of the |
| | tube volume |

### Vapor Pressure Distribution

The vapor and liquid pressure distributions and the temperature can be obtained as:

$$( 1 )$$

$$Δ {p}_{v}^{+} ( {x}^{+} ) = \{ \begin{matrix}- \frac{4 ( 1 - φ )}{( 1 - φ )} {Re}_{h} \{ [ \frac{16 ( 1 - φ )}{25 φ} {Re}_{h} + \frac{2}{2 ( {h}_{b}^{+} )} ] {( {x}^{+} )}^{2} + {\int }_{0}^{{x}^{+}} \frac{{x}^{+}}{{f}^{+} ( {x}^{+} ) ( 1 - {f}^{+} ( {x}^{+} ) )} {dx}^{+} \} , & ( 0 \leq {x}^{+} \leq φ {l}^{+} ) \\ Δ {p}_{v}^{+} ( φ {l}^{+} ) - \frac{4 φ}{( 2 - φ )} {Re}_{h} \{ [ \frac{16 φ}{25 ( 2 - φ )} {Re}_{h} - \frac{1}{2 {( {h}_{b}^{+} )}^{2}} ] [ {( {x}^{+} - {l}^{+} )}^{2} - {( φ {l}^{+} - {l}^{+} )}^{2} ] - {\int }_{0}^{{x}^{+}} \frac{{x}^{+} - {l}^{+}}{{f}^{+} ( {x}^{+} ) ( 1 - {f}^{+} ( {x}^{+} ) )} {dx}^{+} \} , & ( φ {l}^{+} \leq {x}^{+} \leq {l}^{+} )\end{matrix}$$

where f⁺(x⁺) can be given by:

$$\frac{{df}^{+} ( {x}^{+} )}{{dx}^{+}} = \{ \begin{matrix}[ - \frac{9}{2} ( 1 - φ ) {f}^{+} ( {x}^{+} ) + 5 \frac{( 2 - φ )}{{Re}_{h}} \frac{1}{{f}^{+} ( {x}^{+} )} - \frac{5}{2} φ ] \frac{1}{( 1 - φ ) {x}^{+}} , & ( 0 \leq {x}^{+} \leq φ {l}^{+} ) \\ [ - φ {f}^{+} ( {x}^{+} ) + 10 \frac{( 2 - φ )}{{Re}_{h}} \frac{1}{{f}^{+} ( {x}^{+} )} ] \frac{1}{7 φ ( {l}^{+} - {x}^{+} )} , & ( φ {l}^{+} \leq {x}^{+} \leq {l}^{+} )\end{matrix} \qquad ( 2 )$$

### Liquid Pressure Distribution

$$Δ {p}_{l}^{+} ( {x}^{+} ) = \{ \begin{matrix}Δ {p}_{l}^{+} ( {l}^{+} ) - \frac{{h}_{w}^{+} {μ}^{+} ( 1 - φ ) {Re}_{h}}{2 ( 2 - φ ) {K}^{+}} \{ φ ( 1 - φ ) {( {l}^{+} )}^{2} + [ {( φ {l}^{+} )}^{2} - {( {x}^{+} )}^{2} ] \} , & ( 0 \leq {x}^{+} \leq φ {l}^{+} ) \\ Δ {p}_{l}^{+} ( {l}^{+} ) - \frac{{h}_{w}^{+} {μ}^{+} φ {Re}_{h}}{2 ( 2 - φ ) {K}^{+}} {( {l}^{+} - {x}^{+} )}^{2} , & ( φ {l}^{+} \leq {x}^{+} \leq {l}^{+} )\end{matrix} \qquad ( 3 )$$

### Temperature Distribution

$$Δ {T}_{v}^{+} ( {x}^{+} ) = {( {T}_{ov}^{+} )}^{2} [ \frac{{lnp}_{v}^{+ 2} ( {x}^{+} ) - {lnp}_{ov}^{+}}{1 - {T}_{ov}^{+} ( {lnp}_{ov}^{+} - {lnp}_{v}^{+} ( {x}^{+} ) )} ] \qquad ( 4 )$$

One of the major characteristics of the flat-shaped heat pipe 104 is the small temperature difference across the flat-shaped heat pipe 104. Therefore, this can be employed to calculate the effective thermal conductivity of the flat-shaped heat pipe 104 as follows:

$${k}_{eff} = \frac{{Ql}_{eff}}{A Δ T} \qquad ( 5 )$$

where

$${l}_{eff} = ( \frac{{l}_{e} + {l}_{c}}{2} ) + {l}_{a} \qquad ( 6 )$$

and k_{eff} is the effective thermal conductivity of the flat-shaped heat pipe, \dot{Q} is the power transported, l_{eff} is the effective length, A is the cross-sectional area, and ΔT is the temperature difference between evaporator and condenser sections.

### General Thermal Analysis

In case of constant surface heat flux, the conservation of energy equation for the steady flow of a fluid can be expressed as Eq. (7) where \dot{Q}ᵤ is the rate of heat transfer to the fluid, \dot{Q}_{incident} is the rate of heat incident on the collector, \dot{Q}_{com,collector} is the heat loss from the collector by natural convection, \dot{Q}_{rad,collector} is the heat loss from the collector by radiation, \dot{m} is the mass flow rate of the fluid inside, and Tᵢ, and Tₒ are the mean fluid temperatures at the inlet and outlet of the tube, respectively.

\dot{Q}_{incident}−\dot{Q}_{com,collector}−\dot{Q}_{rad,collector}=\dot{Q}ᵤ=\dot{m}Cₚ(Tₒ−Tᵢ) (7)

where

\dot{Q}_{incident}=I_{G}A_{collector}τα (8)

\dot{Q}_{com,collector}=hAₛ(Tₛ−T_{amb}) (9)

\dot{Q}_{rad,collector}=εσAₛ(Tₛ^{A}−T_{amb}^{A}) (10)

where I_{G} is solar irradiation, A_{collector} is surface area of the collector, τ is transmittance (0.96), α is absortance (0.903), h is the average heat transfer coefficient on the surface, Aₛ the heat transfer surface area, Tₛ and T_{amb} are the surface temperature and the ambient temperature, respectively, ε is the emissivity of the surface (0.89), and σ is Stefan-Boltzmann constant (5.67×10⁻⁸ W/m²·K⁴). To estimate the heat loss from the solar collector, the natural convection heat transfer is considered which depends on the geometry of the surface. The empirical correlation for the average Nusselt number for the flat-shaped heat pipe system is presented in Eq. (11), and the average Nusselt number for the evacuated tube system is presented in Eq. (12) as follows:

$${Nu}_{h , plate} = 0.54 {Ra}_{L}^{1 / 4} \qquad ( 11 )$$

$${Nu}_{h , cylinder} = {\{ 0.6 + \frac{0.387 {Ra}_{D}^{1 / 6}}{{[ 1 + {( 0.559 / Pr )}^{9 / 16} ]}^{8 / 27}} \}}^{2} \qquad ( 12 )$$

where Rₐ is the Rayleigh number and Pr is the Prandtl number.

Furthermore, the thermal performance can be presented in the form of thermal resistance for heat transfer devices. It can be expressed as a ratio of the temperature gradient across the heat transfer device on the heat transported which is exhibited in Eq. (13) were Tₑ and T_{c} are the temperature at the evaporator and condenser sections, respectively.

$${R}_{th} = \frac{{T}_{e} - {T}_{c}}{{\dot{Q}}_{u}} \qquad ( 13 )$$

### The Standard Deviation

The standard deviation (SD) is one of the statistical indicators to calculate the distribution between known value and unknown value that divided by the number of sample data. The formula is as shown in Eq. (14). The percentage of the standard deviation (STD) can be determined by dividing the standard deviation by the mean value of the data as presented in Eq. (15) were α is the number of data points, yᵢ and xᵢ are the current values and those values in reference Vafai, K., and Wang, W., 1992, “Analysis of Flow and Heat Transfer Characteristics of an Asymmetrical Flat Plate Heat Pipe,” Int. J. Heat Mass Transfer, 35 (9), pp.2087-2099, respectively, and x̅ is the mean value of xᵢ.

$$SD = \sqrt{\frac{1}{a - 1} {\sum }_{i = 1}^{a} {( {y}_{i} - {x}_{i} )}^{2}} \qquad ( 14 )$$

$$STD = \frac{SD}{\overline{x}} \times 100 \qquad ( 15 )$$

Table 2 displays the results of the surface area of the solar collector, evaporator section, and condenser section of a solar water heating system with a flat-shaped heat pipe and various heat transfer devices for the evacuated tube solar water heating system. As can be seen, the surface area of the solar collector and evaporator sections for these types of heat transfer devices may be less than the surface area of the condenser section for the thermosyphon and closed-loop pulsating heat pipe system and equal to the surface area of the condenser section for the U-tube system. However, in this study, the evaporator section is on top of the flat-shaped heat pipe's surface and the residue of the surface area acts as the condenser section as presented in FIG. 2. It should be noted that the flat-shaped heat pipe has a larger surface area for the condenser section as compared to the surface area of the evaporator section, which affects its remarkable heat transfer rate.

The standard aperture area of solar collectors which is suitable for a single-family is approximately 2 m² (also presented in Table 2). To determine the flat-shaped heat pipe's evaporator surface area based on the aperture area of these solar collectors, its size is designed as 2,000×1,000 mm (l_{b}, xlₑ). In addition, the condenser section is selected for the same length as that of the evaporator section. Therefore, the nominal dimension of the flat-shaped heat pipe can be 2,000×3,000×25.4 mm including 4 mm of the total height of the wick structure and the rest of the volume as a vapor channel. As a result, the flat-shaped heat pipe can weigh approximately seven times less than a solid copper plate of the same size. Additionally, the condenser section of the flat-shaped heat pipe system can possess a surface area five times larger than the solar collector and the evaporator sections.

TABLE 2
The surface area of the flat-shaped heat pipe system and various heat
transfer devices in the evacuated tube solar water heating system.

| Type of heat | A_{collector} | Aₑ | A_{c} | |
|---|---|---|---|---|
| transfer device | (m²) | (m²) | (m²) | Researcher |
| FS-HP | 2.000 | 2.000 | 10.000 | The present work |
| U-tube | 0.177 | 0.061 | 0.061 | Ma et al. |
| Thermosyphon | 2.126 | 0.679 | 0.056 | Wannagosit et al. |
| CLPHP | 2.658 | 0.943 | 0.226 | Siritan et al. |

### Modeling Validation

To verify our model, the vapor pressure distribution, liquid pressure distribution, and temperature distribution along the flat-shaped heat pipe at three different Reynolds numbers, which can correspond to the rate of heat transfer generated and the injection velocity in the evaporator section, can be validated with the analytical results of Vafai and Wang.

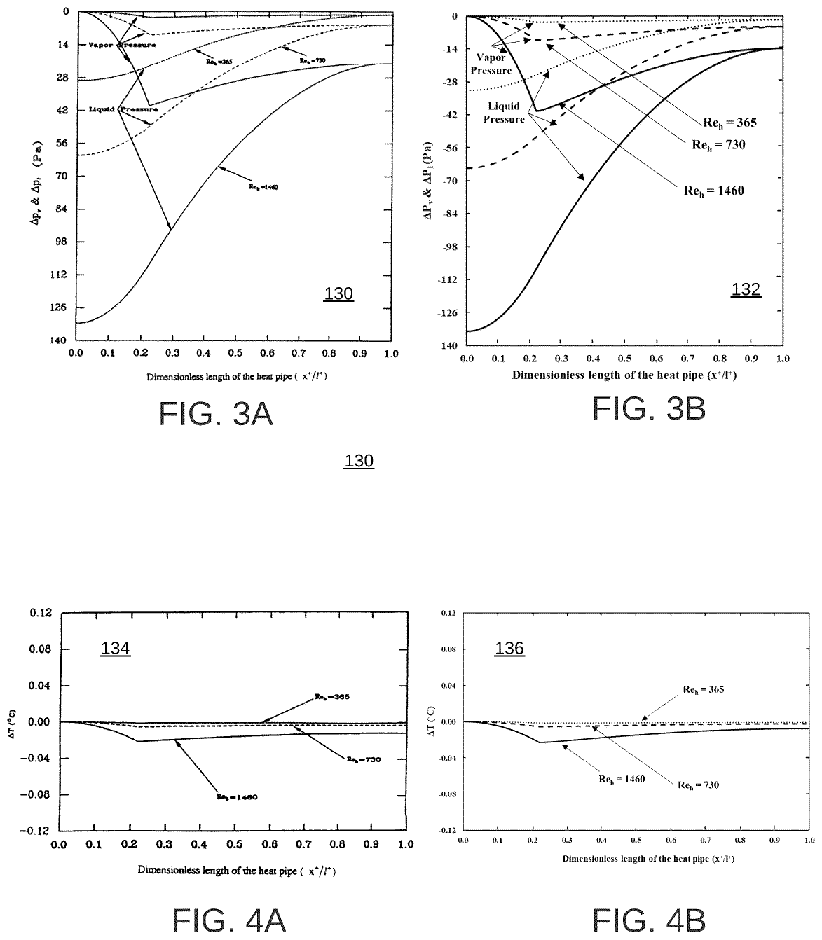

FIG. 3A and FIG. 3B illustrate graphs 130 and 132 depicting a comparison of the vapor and liquid pressure distributions along the flat-shaped heat pipe 104. FIG. 4A and FIG. 4B illustrates graphs 134 and 136 depicting a comparison of the vapor temperature profiles along the flat-shaped heat pipe 104, in accordance with an embodiment.

FIGS. 3A-3B and FIGS. 4A-4B can substantiate the validation for the vapor pressure distribution, liquid pressure distribution, and temperature distribution along the flat-shaped heat pipe for a range of pertinent Reynolds numbers. As can be seen there is perfect agreement between the current work and the results of Vafai and Wang [with ±3.6% STD, which can be calculated from Eq. (15).

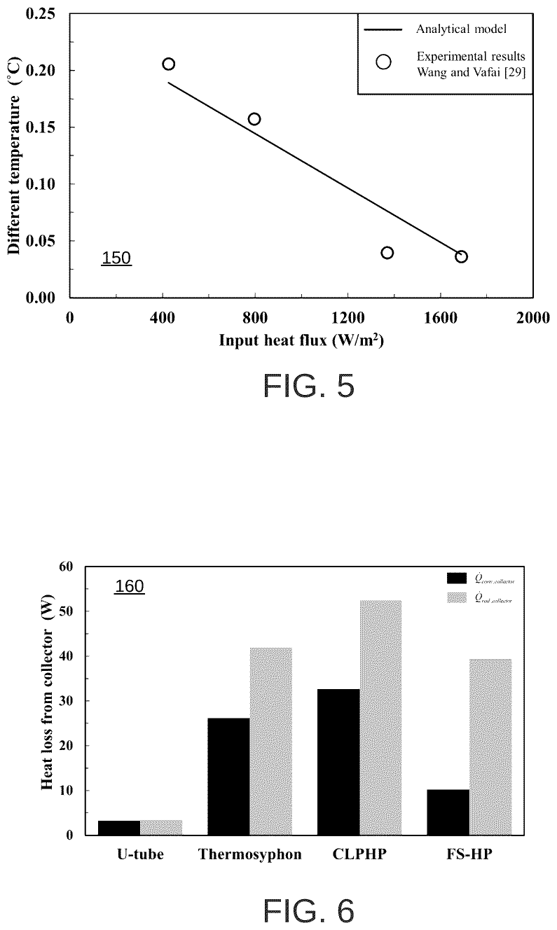

Furthermore, the model can be validated by experimental results, where a flexible heater was designed for supplying heat on the center of one of the outside surfaces of flat-shaped the heat pipe. FIG. 5 illustrates a graph 150 depicting the comparison of the different temperatures between the analytical and experimental results. FIG. 5 indicates that the analytical results agree well with experimental results.

### Results and Discussion

The results of an innovative design for the solar water heating system with a flat-shaped heat pipe are based on the flat-shaped heat pipe using heavy water as the working fluid inside. According to its thermophysical properties, heavy water has the following characteristics: h_{fg}=2,128 kJ/kg. ρᵥ=0.3055 kg/m³, ρₗ=1,078.3 kg/m³, μ=1.1876×10⁻⁵ Ns/m², μₗ=41.6 Ns/m^{b 2}. Moreover, the thickness of sintered copper powder is 1.651 mm with 7×10⁻² m² permeability.

To compare the thermal performance of solar water heating systems for various heat transfer devices, the natural convection and radiation heat losses from the collector to the environment is considered based on the shape of the collectors. In addition, the outer surface temperature of these collectors and ambient temperature can be estimated by experimental results, which have reported that the average outer surface temperature of the evacuated tube collector and ambient temperature is approximately 35.8° C. and 32.5° C., respectively. The estimation of the heat loss from the collector to the environment for the U-tube, thermosyphon, CLPHP, and flat-shaped heat pipe system is presented in graph 160 in FIG. 6.

To estimate heat loss from the collector to the environment for the U-tube, thermosyphon, and CLPHP system, the Nusselt number is calculated by Eq. (12) because the evacuated tube collector has a cylindrical shape. While the Nusselt number for the flat-shaped heat pipe system is calculated by Eq. (11) due to its shape. The results of the U-tube, thermosyphon, and CLPHP system demonstrate that the heat loss from the collector for the CLPHP system is higher than the others because it has the highest number of tubes. In other words, the heat loss from the collector for evacuated tube collectors depends on the surface area of the collector or the number of tubes. However, the flat-shaped heat pipe system has the lowest heat loss from the collector when compared with the evacuated tube collectors which are similar to the surface area of the solar collector (e.g., thermosyphon and CLPHP systems).

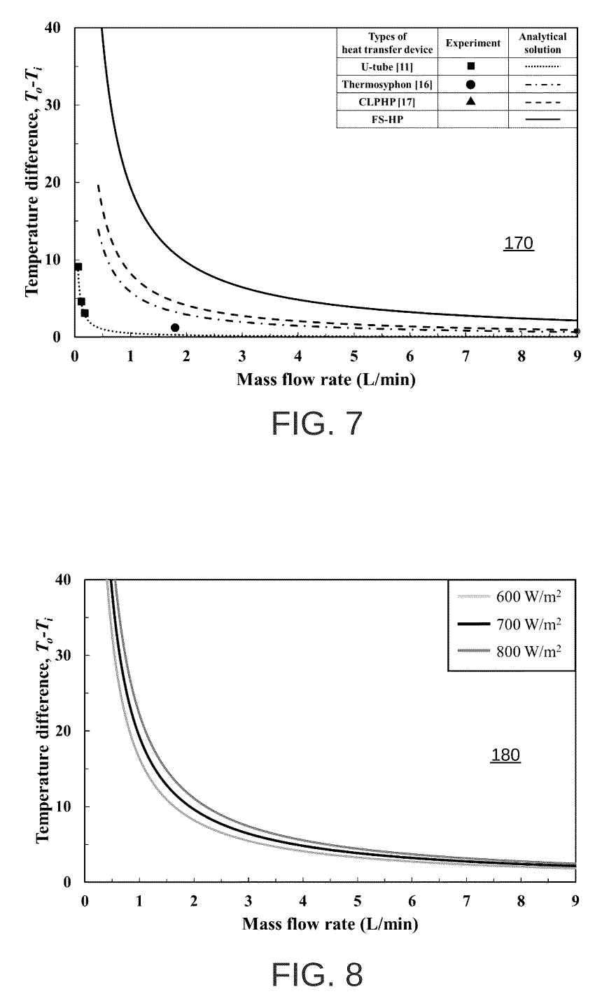

Furthermore, the effect of mass flow rate on the water temperature difference between the inlet and outlet of the tube which is calculated by Eq. (7) is presented in graph 170 in FIG. 7. The solar intensity and the inlet water temperature are taken as 700 W/m² and 25° C., respectively for all heat transfer devices. The analytical results of the evacuated tube solar water heating system with a U-tube, a thermosyphon, and a closed-loop pulsating heat pipe are compared with their experimental results as exhibited in graph 170 of FIG. 7.

It can be observed that the outlet water temperature drops dramatically when the mass flow rate increases to 4 L/min. This is because the water has a shorter time to receive and accumulate the solar energy. At a lower flow rate such as 0.6 L/min mass flow rate, the water temperature difference between the inlet and outlet of the flat-shaped heat pipe system is substantially higher than the U-tube, thermosyphon, and closed-loop pulsating heat pipe system by as much as 31.4, 22.5, and 18.5° C., respectively.

The water temperature difference between the inlet and outlet for the thermosyphon system is lower than that for the current innovative design by as much as 65%. This is due to the surface area of the condenser section is lower than the evaporator section by approximately 12 times. However, the flat-shaped heat pipe can overcome this limit because the surface area of the condenser section is more than the evaporator section by 4 times for the nominal dimension of the flat-shaped heat pipe.

The incident solar irradiation strongly affects the water temperature difference between the inlet and outlet of the flat-shaped heat pipe system as presented in graph 180 in FIG. 8. The results indicate that when the incident solar irradiation increases from 700 to 800 W/m², the water temperature difference between the inlet and outlet of the flat-shaped heat pipe system increases approximately 33%.

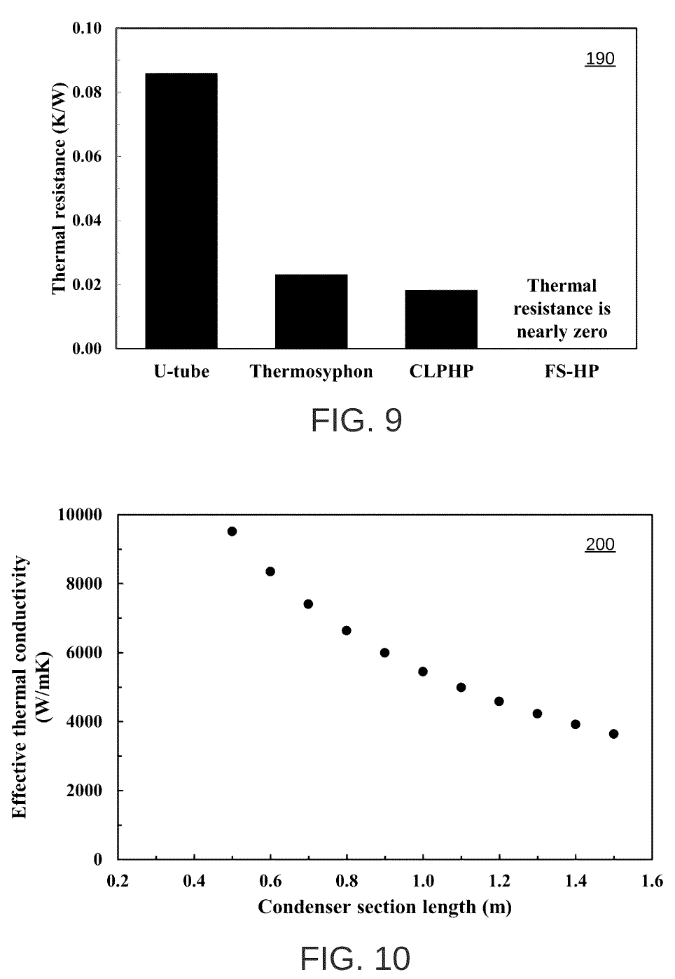

The average thermal resistances of these different heat transfer devices for the solar water heating system are demonstrated in graph 190 of FIG. 9. In order to calculate the thermal resistance of the flat-shaped heat pipe 104, the temperature difference across the flat-shaped heat pipe 104, which can be calculated from Eq. (4), may be employed using different temperatures between the evaporator and condenser sections. While the different temperatures between the evaporator and condenser sections for thermosyphon and closed-loop pulsating heat pipe were provided by other references, it can be seen that the average thermal resistance for the U-tube, thermosyphon, and CLPHP is about 0.086, 0.0232, and 0.0183 K/W, respectively, while it is nearly zero for the flat-shaped heat pipe 104. The thermal resistance for the flat-shaped heat pipe design is lower than that of the U-tube, thermosyphon, and CLPHP designs by 1,870, 500, and 400 times, respectively. It can be concluded that the flat-shaped heat pipe provides the most optimized performance when compared to the other heat transfer devices for the solar water heating system.

To design an optimal sizing of the flat-shaped heat pipe for utilization in the solar water heating system, the effective thermal conductivity can be calculated from Eq. (5). Graph 200 of FIG. 10 presents the effect of the condenser section length of the flat-shaped heat pipe on the effective thermal conductivity. The results indicate that the effective thermal conductivity of the flat-shaped heat pipe increases with a reduction in the length of the condenser section with a constant evaporator section length of 1 m.

The difference in the temperature between the evaporator and condenser sections increases when the condenser section length decreases due to the shorter distance for moving and returning the working fluid inside the flat-shaped heat pipe. In addition, these reductions in the condenser section length also can lead to a sizeable reduction in the weight and cost of the system. However, the ratio of the surface area of the condenser section to the surface area of the evaporator section must be considered in order to take full advantage over traditional heat transfer devices.

The optimization and thermal performance of an innovative design for a solar water heating system using flat-shaped heat pipes as a heat transfer device are investigated in this work. The model of the flat-shaped heat pipe is meticulously validated with the established analytical results. Their thermal performances are compared with the experimental results of a U-tube, thermosyphon, and a closed-loop pulsating heat pipe which is used as a heat transfer device in the evacuated tube solar water heating system. The following main conclusions can be drawn:
(1) The water temperature difference between the inlet and outlet for the flat-shaped heat pipe system is considerably higher than the U-tube, thermosyphon, and closed-loop pulsating heat pipe system by as much as 31.4, 22.5, and 18.5° C., respectively at a nominal 0.6 L/min mass flow rate.
(2) The average thermal resistance for the flat-shaped heat pipe is nearly zero and much lower than the U-tube, thermosyphon, and closed-loop pulsating heat pipe system by 1,870, 500, and 400 times, respectively.
(3) This innovative system also leads to very substantial reduction in the weight and cost of the proposed solar water heating system.

Embodiments relate to an innovative design for a solar water heating system using a flat-shaped heat pipe as a heat transfer device that can pave the way for a substantial increase in the thermal performance of these systems. An analytical study has been utilized to investigate the thermal performance of the solar water heating system. The analytical results for the flat-shaped heat pipe system are compared with the results of the evacuated tube solar water heating system with a U-tube, thermosyphon, and closed-loop pulsating heat pipe. It has been found that the water temperature difference between the inlet and outlet of the flat-shaped heat pipe system is substantially higher than the U-tube, thermosyphon, and closed-loop pulsating heat pipe system by as much as, for example, 31.4, 22.5, and 18.5° C., respectively at a nominal 0.6 L/min mass flow rate. Furthermore, utilizing the flat-shaped heat pipe in the solar water heating system can optimize the thermal conductivity of the solar setup due to a reduction in the condenser section length. These reductions can also lead to a large reduction in the weight and cost of the system.

Nomenclature used herein is as follows:

Nomenclature

| | |
|---|---|
| A | surface area (m²) |
| b | half-width of any of the vapor channels (m) |
| Cₚ | specific heat at constant pressure (J (kg · K)⁻¹) |
| f⁺ (x⁺) | dimensionless position of the maximum vapor velocity in y⁺ |
| | direction |
| h | height of vapor space for the heat pipe (m) |
| h | heat transfer coefficient (W (m · K)⁻¹) |
| h_{fg} | latent heat of working fluid (kJ · kg⁻¹) |
| h_{w} | thickness of the wick (m) |
| h_{b}⁺ | dimensionless half-width of any of the vapor channels, b/h |
| h_{w}⁺ | dimensionless thickness of the wick, h_{w}/h |
| I_{G} | solar radiation (W · m²) |
| K | permeability (m²) |
| K⁺ | dimensionless permeability, K/h_{w}² |
| k_{eff} | effective thermal conductivity (W (m · K)⁻¹) |
| l | length (m) |
| l_{eff} | effective length (m) |
| l⁺ | dimensionless length of the heat pipe |
| \dot{m} | mass flow rate of fluid (kg · s⁻¹) |
| Nu | Nusselt number |
| pₗ | liquid pressure (Pa) |
| pᵥ | vapor pressure (Pa) |
| p₀ᵥ | saturate vapor pressure (Pa) |
| pₗ⁺ | dimensionless liquid pressure, pₗ/ρₗv₁² |
| pᵥ⁺ | dimensionless vapor pressure, pᵥ/ρᵥv₁² |
| p₀ᵥ⁺ | dimensionless saturate vapor pressure, p₀ᵥ/ρᵥv₁² |
| Δpₗ⁺ | overall dimensionless liquid pressure drop along the heat pipe |
| Δpᵥ⁺ | overall dimensionless vapor pressure drop along the heat pipe |
| Pr | Prandtl number |
| q | heat flux (W · m⁻²) |
| Q | heat transfer rate (W) |
| R | ideal gas constant = 8.31433 (kJ · (kmol · K)⁻¹) |
| Rₜₕ | thermal resistance (K/W) |
| Ra | Rayleigh number |
| Reₕ | injection Reynolds number, v₁h/vᵥ |
| T | temperature (K) |
| T₀ᵥ | saturate vapor temperature (K) |
| T₀ᵥ⁺ | dimensionless saturate vapor temperature |
| ΔTᵥ⁺ | dimensionless vapor temperature drop along the heat pipe |
| v₁ | vapor injection velocity (m · s⁻¹) |
| x, y, z | Cartesian coordinates |

Greek symbols

| | |
|---|---|
| Δ | delta |
| μₗ | vapor viscosity (Ns · m⁻²) |
| μᵥ | liquid viscosity (Ns · m⁻²) |
| μ⁺ | dimensionless viscosity, μᵥ/μₗ |
| ν | kinematic viscosity (m² · s⁻¹) |
| ρ | density (kg · m⁻³) |
| φ | ratio of the evaporator length to the heat pipe length |
| α | absorptance |
| τ | transmittance |
| ε | emissivity |
| σ | Stefan-Boltzmann constant = 5.67 × 10⁻⁸ (W · m⁻² · K⁻⁴) |

Subscripts

| | |
|---|---|
| a | adiabatic section |
| b | width of the heat pipe |
| c | condenser section |
| e | evaporator section |
| h | horizontal mode |
| i | inlet |
| o | outlet |
| s | surface |
| u | useful heat |
| amb | ambient |
| collector | solar collector |
| conv | convection |
| rad | radiation |

Superscript

| | |
|---|---|
| + | dimensionless quantities |

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A solar water heating system, comprising:
a flat-shaped heat pipe comprising a heat transfer device.

2. The solar water heating system of claim 1 wherein a plurality of insulated rectangular ducts are located at a top of the flat-shaped heat pipe.

3. The solar water heating system of claim 1 wherein an insulated rectangular duct is located at a bottom of the flat-shaped heat pipe.

4. The solar water heating system of claim 1 further comprising an absorber that receives, collets and transfers heat to the flat-shaped heat pipe.

5. The solar water heating system of claim 5 further comprising a glass cover that reduces heat loss from the absorber.

6. The solar water heating system of claim 1 wherein the flat-shaped heat pipe comprises a copper plate, which includes porous wicks located on an inner surface of a wall of the flat-shaped heat pipe.

7. The solar water heating system of claim 1 wherein the flat-shaped heat pipe is filled with a working fluid.

8. A solar water heating system comprising:
a flat-shaped heat comprising a plate, said flat-shaped heat pipe having porous wicks on the inner surfaces of the flat-shaped heat pipe wall;
two small insulated rectangular ducts positioned at the top of the flat-shaped heat pipe;
a large insulated rectangular duct located at the bottom of the flat-shaped heat pipe;
an absorber configured to receive, collect, and transfer heat from the sun to the flat-shaped heat pipe; a glass cover positioned to reduce heat loss from the absorber;
said flat-shaped heat pipe filled with a working fluid; and
a mechanism to transfer heat to water flowing through the flat-shaped heat pipe in rectangular ducts situated outside the flat-shaped heat pipe when solar irradiation is incident through the glass cover on the absorber, causing the working fluid inside the flat-shaped heat pipe to evaporate to vapor and transfer equally to both sides of the heat pipe.

9. The solar water heating system of claim 8 wherein the plate is configured from copper.
